(19) United States
(12) Patent Application Publication
(10) Pub. No.: US 2026/0125060 A1
(43) Pub. Date: May 7, 2026

(54) DRIVING CONTROL DEVICE, DRIVING CONTROL METHOD, AND NON-TRANSITORY COMPUTER-READABLE STORAGE MEDIUM

(71) Applicant: HONDA MOTOR CO., LTD., Tokyo (JP)

(72) Inventor: Yasuaki MORI, Tokyo (JP)

(21) Appl. No.: 19/359,202

(22) Filed: Oct. 15, 2025

(30) Foreign Application Priority Data
Nov. 1, 2024 (JP) 2024-193252

(51) Int. Cl. B60W 30/18; B60W 30/14; B60W 60/00

(52) U.S. Cl. CPC B60W 30/18027; B60W 30/14; B60W 60/0015; B60W 2540/10; B60W 2540/12; B60W 2540/221

(57) ABSTRACT

A driving control device of a vehicle includes a surrounding environment recognizer configured to recognize a surrounding environment of the vehicle, a travel controller configured to control acceleration and deceleration of the vehicle according to a driving mode, a mode setter configured to change the driving mode, and an operation detector configured to detect a brake pedal operation by an occupant. The driving mode includes a start standby mode in which the travel controller starts the vehicle according to the surrounding environment when the vehicle is stopped, and a stop maintenance mode in which the travel controller maintains a stopped state of the vehicle when the vehicle is stopped, and in a case where the driving mode is the start standby mode and the brake pedal operation is detected, the mode setter changes the driving mode from the start standby mode to the stop maintenance mode.

### TECHNICAL FIELD

The present invention relates to a driving control device, a driving control method, and a non-transitory computer-readable storage medium.

### BACKGROUND ART

In recent years, there have been increasing efforts to provide sustainable transport systems that take into consideration vulnerable transport participants. To achieve this, research and development of driving assistance technologies is conducted to further improve road safety and convenience.

For example, WO2016/181725 and WO2018/159399 disclose a driving control device that enables autonomous driving. The driving control device has the function of accelerating and decelerating a vehicle according to a surrounding environment of the vehicle.

Such a driving control device may have the function of starting the vehicle from a stopped state according to the surrounding environment. However, if the vehicle starts at a timing against the intention of an occupant, the occupant may feel uncomfortable.

### SUMMARY OF THE INVENTION

In view of the above background, an object of one aspect of the present invention is to provide a driving control device, a driving control method, and a storage medium that enable a vehicle to start according to the intention of an occupant. Thus, the one aspect of the present invention aims to contribute to the development of sustainable transport systems.

To achieve such an object, one aspect of the present invention provides a driving control device of a vehicle comprising: a surrounding environment recognizer configured to recognize a surrounding environment of the vehicle; a travel controller configured to control acceleration and deceleration of the vehicle according to a driving mode; a mode setter configured to change the driving mode; and an operation detector configured to detect a brake pedal operation by an occupant, wherein the driving mode includes: a start standby mode in which the travel controller starts the vehicle according to the surrounding environment when the vehicle is stopped; and a stop maintenance mode in which the travel controller maintains a stopped state of the vehicle when the vehicle is stopped, and in a case where the driving mode is the start standby mode and the brake pedal operation is detected, the mode setter changes the driving mode from the start standby mode to the stop maintenance mode.

Another aspect of the present invention provides a driving control method comprising: detecting, by a computer, a surrounding environment of a vehicle; controlling, by the computer, acceleration and deceleration of the vehicle according to a driving mode including a start standby mode in which the vehicle is started according to the surrounding environment when the vehicle is stopped and a stop maintenance mode in which a stopped state of the vehicle is maintained when the vehicle is stopped; and changing, by the computer, the driving mode from the start standby mode to the stop maintenance mode in a case where the driving mode is the start standby mode and a brake pedal operation is detected.

Another aspect of the present invention provides a non-transitory computer-readable storage medium comprising a control program, wherein the control program, when executed by a computer, executes a driving control method comprising: detecting, by the computer, a surrounding environment of a vehicle; controlling, by the computer, acceleration and deceleration of the vehicle according to a driving mode including a start standby mode in which the vehicle is started according to the surrounding environment when the vehicle is stopped and a stop maintenance mode in which a stopped state of the vehicle is maintained when the vehicle is stopped; and changing, by the computer, the driving mode from the start standby mode to the stop maintenance mode in a case where the driving mode is the start standby mode and a brake pedal operation is detected.

Thus, according to the above aspects, it is possible to provide a driving control device, a driving control method, and a storage medium that enable control of equipment according to the intention of an occupant.

### BRIEF DESCRIPTION OF THE DRAWING(S)

FIG. 1 is a block diagram of a vehicle provided with a driving control device according to an embodiment;

FIG. 2 is a transition diagram of a control mode (driving mode) of the driving control device according to the embodiment;

FIG. 3 is a flowchart showing a procedure for stopped time driving assistance control executed by the driving control device according to the embodiment; and

FIG. 4 is a flowchart showing the procedure for the stopped time driving assistance control executed by the driving control device according to the embodiment.

### DETAILED DESCRIPTION OF THE INVENTION

In the following, the embodiments of a driving control device, a driving control method, and a non-transitory computer-readable storage medium will be described with reference to the drawings.

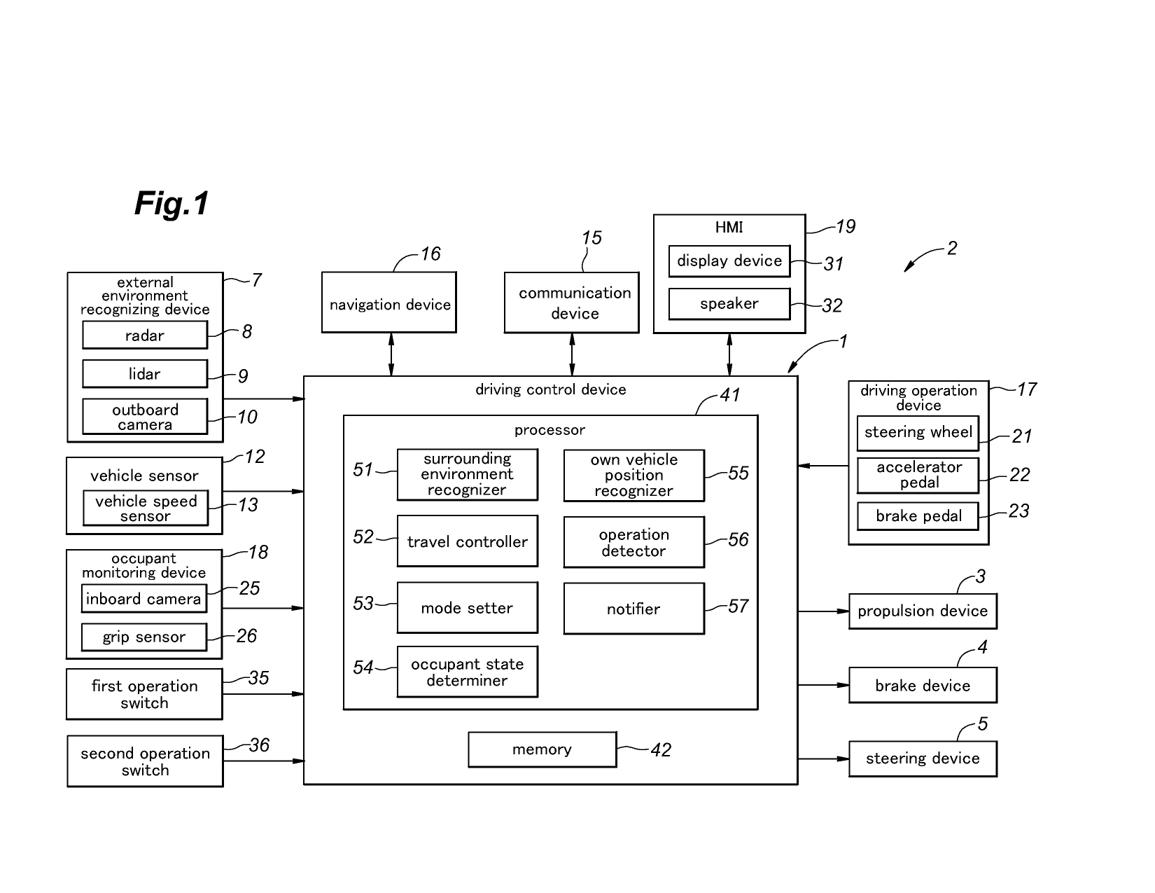

As shown in FIG. 1, a driving control device 1 is provided in a vehicle 2. The vehicle 2 may be, for example, a four-wheeled automobile. The vehicle 2 is an autonomous driving vehicle or a vehicle with a driving assistance function. In the following, "the start of the vehicle 2" means "the start of movement of the vehicle 2" and "the vehicle 2 starts" means "the vehicle 2 starts moving".

The vehicle 2 includes a propulsion device 3, a brake device 4, and a steering device 5. The propulsion device 3 is a device that provides the driving force to the vehicle 2, and includes, for example, a power source and a transmission. The power source includes at least one of an internal combustion engine such as a gasoline engine or a diesel engine, and an electric motor. The brake device 4 is a device that applies the braking force to the vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism. The propulsion device 3, the brake device 4, and the steering device 5 are controlled by the driving control device 1.

The vehicle 2 includes an external environment recognizing device 7. The external environment recognizing device 7 is a device for detecting objects outside the vehicle 2 and the like. The external environment recognizing device 7 is a sensor that captures electromagnetic waves and light from the surroundings of the vehicle 2 to detect the objects outside the vehicle 2. The external environment recognizing device 7 includes, for example, a radar 8, a lidar 9 (LIDAR), and an outboard camera 10.

The vehicle 2 includes a vehicle sensor 12. The vehicle sensor 12 includes a vehicle speed sensor 13 that detects the speed of the vehicle 2, an acceleration sensor that detects the acceleration thereof, a yaw rate sensor that detects the angular velocity around the vertical axis, the azimuth sensor that detects the orientation of the vehicle 2, and the like.

The vehicle 2 includes a communication device 15, a navigation device 16, a driving operation device 17, an occupant monitoring device 18, and an HMI 19 (Human Machine Interface). The communication device 15 mediates communication between the components (for example, the driving control device 1 and the navigation device 16) of the vehicle 2 and the devices (for example, a surrounding vehicle and a server) arranged outside the vehicle 2.

The navigation device 16 is a device that acquires the current position of the vehicle 2 and provides route guidance to the destination, and the like. The navigation device 16 may include a GNSS receiving unit, a map storage unit, a navigation interface, and a route determination unit. The GNSS receiving unit determines the position (latitude and longitude) of the vehicle 2 based on signals received from artificial satellites (positioning satellites). The map storage unit is composed of a known storage device such as flash memory or a hard disk, and stores map information. The navigation interface accepts the input of information such as the destination by the occupant, and presents various information to the occupant via display and audio. The navigation interface may include, for example, a touch panel display, a speaker 32, and the like.

The driving operation device 17 accepts input operations performed by the occupant (driver) to control the vehicle 2. The driving operation device 17 includes a steering wheel 21, an accelerator pedal 22, and a brake pedal 23. The driving operation device 17 may also include a shift lever, a parking brake lever, and the like. Each component of the driving operation device 17 is provided with a sensor that detects the operation amount. The driving operation device 17 outputs a signal indicating the operation amount to the driving control device 1.

The occupant monitoring device 18 monitors the state of the occupant inside a vehicle cabin. The occupant monitoring device 18 includes, for example, an inboard camera 25 that captures an image of the occupant seated on a seat inside the vehicle cabin, and a grip sensor 26 provided on the steering wheel 21. The inboard camera 25 is a digital camera that uses a solid-state image sensor such as a CCD or CMOS. The grip sensor 26 detects whether the driver is gripping the steering wheel 21. The grip sensor 26 may be formed, for example, of a capacitance sensor or a piezoelectric element provided on the steering wheel 21.

The HMI 19 notifies the occupant of various information by display and sound, and accepts input operations by the occupant. The HMI 19 includes a display device 31 and a speaker 32. The display device 31 may be a touch panel display including a liquid crystal display or an organic electroluminescence display. The display device 31 may also serve as the navigation interface. The display device 31 and the speaker 32 function as a notification device for making a notification to the occupant by images and sounds. The images may be a video including a plurality of consecutive frames.

The vehicle 2 includes a first operation switch 35 and a second operation switch 36. The first operation switch 35 and the second operation switch 36 are switches that can be operated by the occupant. The first operation switch 35 and the second operation switch 36 may be mechanical switches or GUI switches displayed on a touch panel, and are arranged at appropriate positions inside the vehicle cabin. The first operation switch 35 and the second operation switch 36 may be composed of the display device 31 or the navigation interface. The first operation switch 35 may be a switch for turning on and off the driving assistance control. The second operation switch 36 may be a switch for resuming the driving assistance control. The second operation switch 36 may be, for example, a rotary switch. The first operation switch 35 and the second operation switch 36 may be integrated into a common switch.

As shown in FIG. 1, the driving control device 1 is a computer including a processor 41 and a memory 42 communicatively connected to the processor 41. The processor 41 may include at least one of the following cores: a central processing unit (CPU), a graphics processing unit (GPU), and a reduced instruction set computer (RISC). The memory 42 stores the control program executed by the processor 41 and various data. The memory 42 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the driving control device 1 may be realized by hardware such as a large scale integration (LSI ),an application specific integrated circuit (ASIC), or a field-programmable gate array (FPGA), or may be realized by a combination of software and hardware. The driving control device 1 may be composed of a single piece of hardware, or may be composed of plural pieces of hardware capable of communicating with each other. A portion of the driving control device 1 may be composed of an external server provided outside the vehicle 2.

The processor 41 realizes various applications by executing the control program stored in the memory 42. The control program may be stored in a removable recordable medium such as a DVD or a CD-ROM, and installed in the memory 42 as the recordable medium is read by a reading device. The control program may also be downloaded and installed in the memory 42 via a communication network such as the Internet.

By executing the control program stored in the memory 42, the processor 41 functions as a surrounding environment recognizer 51, a travel controller 52, a mode setter 53, an occupant state determiner 54, an own vehicle position recognizer 55, an operation detector 56, and a notifier 57. The processor 41 executes the control program and the driving control device 1, which is a computer, executes a driving control method. The memory 42 functions as a non-transitory computer-readable storage medium comprising the control program. The control program, when executed by the processor 41 of the driving control device 1, executes the driving control method.

The surrounding environment recognizer 51 recognizes the surrounding environment of the vehicle 2. The surrounding environment recognizer 51 recognizes the surrounding environment (external environment), including obstacles arranged around the vehicle 2, the shapes of roads, the presence or absence of sidewalks, road markings, and the like, based on the detection results of the external environment recognizing device 7. The obstacles include, for example, guardrails, utility poles, surrounding vehicles, and people such as pedestrians. The surrounding environment recognizer 51 can acquire the position, speed, acceleration, and other states of the surrounding vehicles from the detection results of the external environment recognizing device 7.

The own vehicle position recognizer 55 recognizes the lane in which the vehicle 2 is traveling, and the relative position and angle of the vehicle 2 with respect to the lane in which the vehicle 2 is traveling. The own vehicle position recognizer 55 may recognize the traveling lane based on the map information and the position of the vehicle 2 acquired by the GNSS receiving unit. Further, the own vehicle position recognizer 55 extracts the dividing lines around the vehicle 2 drawn on the road surface from the map information and compares the dividing lines from the map information with the shapes of the dividing lines captured by the outboard camera 10, thereby recognizes the relative position and angle of the vehicle 2 with respect to the traveling lane.

The occupant state determiner 54 determines the state of the occupant. The occupant state determiner 54 determines, based on a signal from the occupant monitoring device 18, whether the state of the occupant as the driver is a surrounding monitoring state. The surrounding monitoring state is a state where the occupant is monitoring the surroundings of the vehicle 2. In the surrounding monitoring state, it is preferable that the occupant is in a state where the occupant can start a manual operation quickly. For example, in the surrounding monitoring state, the occupant as the driver is seated on the seat facing forward and monitors the area in front of the vehicle 2. The occupant state determiner 54 may, for example, acquire the sightline of the occupant based on an image from the inboard camera 25, and determine that the state of the occupant is the surrounding monitoring state in a case where the sightline of the occupant is directed forward. Further, the occupant state determiner 54 may, for example, acquire the posture or head direction of the occupant based on an image from the inboard camera 25, and determine that the state of the occupant is the surrounding monitoring state in a case where the posture or head direction of the occupant corresponds to the prescribed surrounding monitoring posture. Further, in a case where the occupant is gripping the steering wheel 21 based on a signal from the grip sensor 26, the occupant state determiner 54 may determine that the state of the occupant is the surrounding monitoring state. Further, the occupant state determiner 54 may determine that the state of the occupant is the surrounding monitoring state in a case where the sightline of the occupant is directed forward and the steering wheel 21 is being gripped by the occupant.

The operation detector 56 acquires the operation amount of the driving operation device 17 based on a signal from the driving operation device 17. The operation detector 56 acquires the operation amounts of the brake pedal 23, the accelerator pedal 22, and the steering wheel 21 based on signals from sensors provided on the brake pedal 23, the accelerator pedal 22, and the steering wheel 21. That is, the operation detector 56 is configured to detect the brake pedal operation, the accelerator pedal operation, and the steering wheel operation by the occupant.

The operation detector 56 is configured to detect the operations on the first operation switch 35 and the second operation switch 36 by the occupant based on signals from the first operation switch 35 and the second operation switch 36.

The travel controller 52 is configured to control the acceleration and deceleration of the vehicle 2 according to the driving mode. The travel controller 52 may also be configured to control the steering of the vehicle 2 in addition to the acceleration and deceleration of the vehicle 2. The travel controller 52 executes adaptive cruise control (hereinafter, referred to as ACC) or autonomous driving control. The travel controller 52 controls the acceleration and deceleration of the vehicle 2 by controlling the propulsion device 3 and the brake device 4. Further, the travel controller 52 controls the steering device 5 and thereby controls the steering of the vehicle 2.

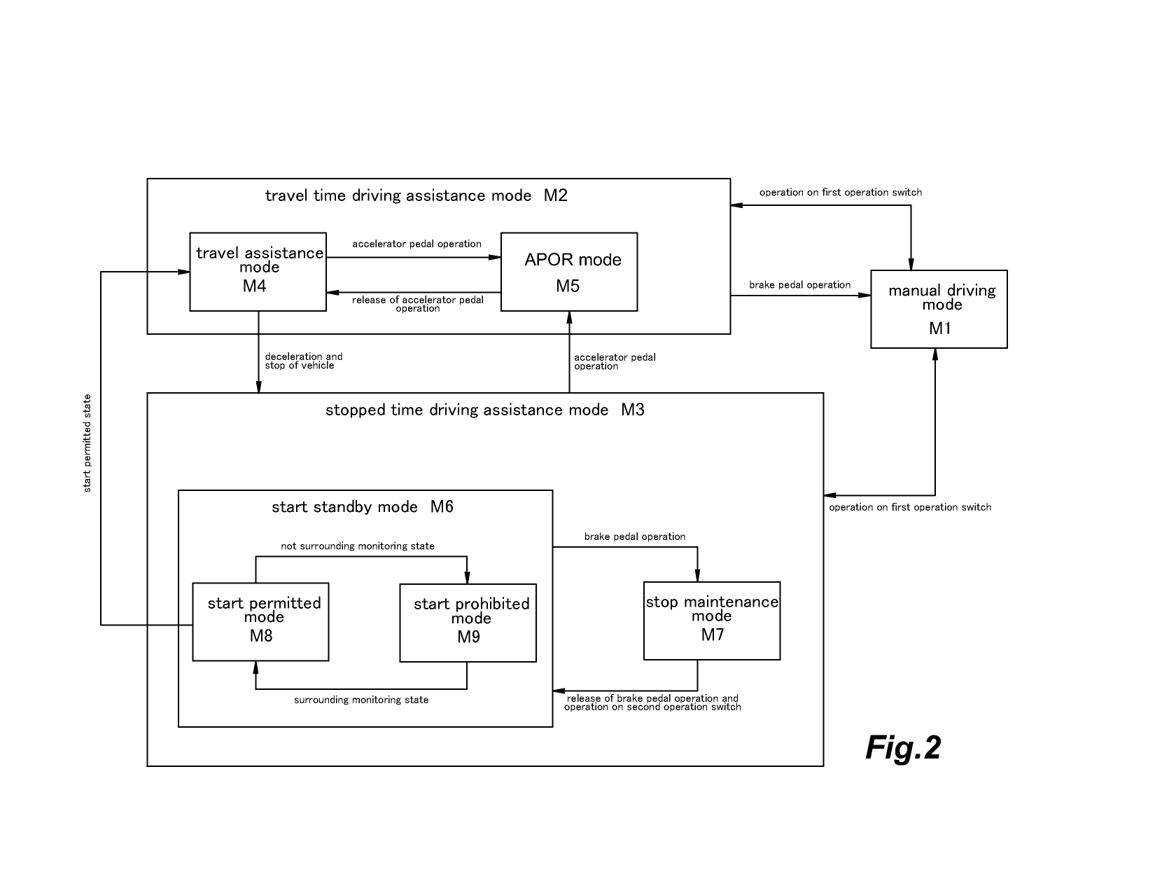

The mode setter 53 is configured to change the driving mode. As shown in FIG. 2, the driving mode includes a manual driving mode M1, a travel time driving assistance mode M2, and a stopped time driving assistance mode M3. Further, the travel time driving assistance mode M2 includes a travel assistance mode M4 and an accelerator pedal override mode M5 (hereinafter referred to as "the APOR mode M5"). The stopped time driving assistance mode M3 includes a start standby mode M6 and a stop maintenance mode M7. The start standby mode M6 includes a start permitted mode M8 and a start prohibited mode M9.

In the manual driving mode M1, the travel controller 52 controls the vehicle 2 based on the driving operations of the occupant. More specifically, in the manual driving mode M1, the travel controller 52 acquires the operation amount of the brake pedal 23 from the brake pedal 23 and controls the brake device 4 based on the operation amount of the brake pedal 23. Further, in the manual driving mode M1, the travel controller 52 acquires the operation amount of the accelerator pedal 22 from the accelerator pedal 22 and controls the propulsion device 3 based on the operation amount of the accelerator pedal 22. Further, in the manual driving mode M1, the travel controller 52 acquires the operation amount of the steering wheel 21 from the steering wheel 21 and controls the steering device 5 based on the operation amount of the steering wheel 21.

The travel assistance mode M4 can be set when the vehicle 2 is traveling In the travel assistance mode M4, the travel controller 52 controls the acceleration and deceleration of the vehicle 2 according to the surrounding environment. The surrounding environment includes, for example, a preceding vehicle traveling in front of the vehicle 2. In the travel assistance mode M4, the travel controller 52 controls the propulsion device 3 and the brake device 4 so as to maintain the inter-vehicle distance between the vehicle 2 and the preceding vehicle traveling in front of the vehicle 2 equal to or more than a prescribed value, and to maintain the vehicle speed at the target vehicle speed within a range in which the inter-vehicle distance can be maintained. The travel controller 52 acquires the position and speed of the preceding vehicle based on the surrounding environment acquired by the surrounding environment recognizer 51. The target vehicle speed may be set by the occupant. The target vehicle speed may be set by the operation on the display device 31 or the operation switch by the occupant. Further, in the travel assistance mode M4, the travel controller 52 may control the propulsion device 3 and the brake device 4 based on signal information about traffic lights acquired by the surrounding environment recognizer 51.

The APOR mode M5 is set as the accelerator pedal 22 is pressed (the accelerator pedal operation is detected) when the driving mode is the travel assistance mode M4. In the APOR mode M5, the travel controller 52 controls the propulsion device 3 based on the pressing amount of the accelerator pedal 22. This enables the vehicle 2 to accelerate according to the accelerator pedal operation by the occupant.

In the travel assistance mode M4, when the preceding vehicle decelerates and stops, the travel controller 52 stops the vehicle 2 while maintaining the inter-vehicle distance between the vehicle 2 and the preceding vehicle. Further, in the travel assistance mode M4, the travel controller 52 may acquire the signal information and stop the vehicle 2 at a stop line according to the signal information. Further, in the travel assistance mode M4 the travel controller 52 may execute known travel control such as lane departure prevention assistance control for causing the vehicle 2 to travel along a lane.

The start standby mode M6 and the stop maintenance mode M7 can be set when the vehicle 2 is stopped. The start standby mode M6 includes the start permitted mode M8 in which the start of the vehicle 2 is permitted, and the start prohibited mode M9 in which the start (ie the start of movement) of the vehicle 2 is prohibited.

In the start standby mode M6, the mode setter 53 changes between the start permitted mode M8 and the start prohibited mode M9 according to the state of the occupant. In the present embodiment, the mode setter 53 changes between the start permitted mode M8 and the start prohibited mode M9 according to the surrounding monitoring state of the occupant. The mode setter 53 sets the driving mode to the start permitted mode M8 in a case where the state of the occupant is the surrounding monitoring state, and sets the driving mode to the start prohibited mode M9 in a case where the state of the occupant is not the surrounding monitoring state.

In the start permitted mode M8, the travel controller 52 maintains the vehicle 2 in a stopped state based on the surrounding environment. For example, in a case where the preceding vehicle is stopped in front of the vehicle 2, or in a case where the signal information in front of the vehicle 2 is a stop signal, the travel controller 52 maintains the vehicle 2 in the stopped state in the start permitted mode M8. At this time, the travel controller 52 controls the brake device 4 to maintain the vehicle 2 in the stopped state.

In the start permitted mode M8, when the surrounding environment turns into the start permitted state in which the start of the vehicle 2 is permitted, the mode setter 53 changes the driving mode from the start permitted mode M8 to the travel assistance mode M4. The start permitted state includes a state where the preceding vehicle that has been stopped in front of vehicle 2 starts, or a case (state) where the signal information in front of the vehicle 2 is a traveling signal (moving signal). As the driving mode changes from the start permitted mode M8 to the travel assistance mode M4, the travel controller 52 controls the brake device 4 and the propulsion device 3 to start the vehicle 2.

In the start prohibited mode M9, the travel controller 52 controls the brake device 4 to maintain the vehicle 2 in the stopped state. In the start prohibited mode M9, even if the surrounding environment becomes a state that permits the vehicle 2 to start, the travel controller 52 maintains the vehicle 2 in the stopped state.

In the stop maintenance mode M7, the travel controller 52 maintains the stopped state of the vehicle 2. In the stop maintenance mode M7, the travel controller 52 controls the brake device 4 to maintain the vehicle 2 in the stopped state. This allows the vehicle 2 to be maintained in the stopped state even if the occupant does not press the brake pedal 23. In the stop maintenance mode M7, the travel controller 52 maintains the vehicle 2 in the stopped state even if the surrounding environment becomes a state that permits the vehicle 2 to start.

When the driving mode is the stop maintenance mode M7,the notifier 57 controls at least one of the display device 31 and the speaker 32, which serves as the notification device, and thereby makes the notification. The notification may include, for example, the information that the stop maintenance mode M7 is selected, the operation method for canceling the stop maintenance mode M7, and the like. This allows the occupant to recognize that the driving mode is the stop maintenance mode M7 and to confirm the operation method for canceling the stop maintenance mode M7. Further, in a case where the driving mode is the stop maintenance mode M7 and the surrounding environment is in the start permitted state, the notifier 57 controls the notification device and thereby makes the notification. This enables the occupant to recognize that the vehicle 2 does not start because the driving mode is the stop maintenance mode M7.

When the driving mode is the start prohibited mode M9 of the start standby mode M6, the notifier 57 controls at least one of the display device 31 and the speaker 32, which serves as the notification device, and thereby makes the notification. The notification may include, for example, the information that the start prohibited mode M9 is selected, the method for canceling the start prohibited mode M9, and the like. This allows the occupant to recognize that the state of the occupant is not the surrounding monitoring state. Further, in a case where the driving mode is the start prohibited mode M9 of the start standby mode M6 and the surrounding environment is in the start permitted state, the notifier 57 may control the notification device and thereby make the notification. This enables the occupant to recognize that the vehicle 2 does not start because the state of the occupant is not the surrounding monitoring state.

As shown in FIG. 2, the driving mode transitions according to the operation by the occupant, the state of vehicle 2, and the state of the occupant. When the first operation switch 35 for switching on and off the driving assistance control is turned on by the occupant in a case where the driving mode is the manual driving mode M1 and the vehicle 2 is in the traveling state, the mode setter 53 changes the driving mode from the manual driving mode M1 to the travel time driving assistance mode M2. At this time in a case where the accelerator pedal 22 is pressed, the mode setter 53 may change the driving mode from the manual driving mode M1 to the APOR mode M5. On the other hand, in a case where the accelerator pedal 22 is not pressed, the mode setter 53 may change the driving mode from the manual driving mode M1 to the travel assistance mode M4.

When pressing of the accelerator pedal 22 (accelerator pedal operation) is detected based on the signal from the accelerator pedal 22 in a case where the driving mode is the travel assistance mode M4,the mode setter 53 changes the driving mode from the travel assistance mode M4 to the APOR mode M5. When the release of pressing of the accelerator pedal 22 (accelerator pedal operation) is detected based on the signal from the accelerator pedal 22 in a case where the driving mode is the APOR mode M5,the mode setter 53 changes the driving mode from the APOR mode M5 to the travel assistance mode M4.

When pressing of the brake pedal 23 is detected based on the signal from the brake pedal 23 in a case where the driving mode is the travel assistance mode M4, the mode setter 53 changes the driving mode from the travel assistance mode M4 to the manual driving mode M1.

In a case where the driving mode is the travel assistance mode M4 and the vehicle 2 decelerates and stops, the mode setter 53 changes the driving mode from the travel assistance mode M4 to the start standby mode M6. The start standby mode M6 selected at this time may be the start permitted mode M8. When the state of the occupant is no longer the surrounding monitoring state in a case where the driving mode is the start permitted mode M8, the mode setter 53 changes the driving mode from the start permitted mode M8 to the start prohibited mode M9. When the state of the occupant becomes the surrounding monitoring state in a case where the driving mode is the start prohibited mode M9, the mode setter 53 changes the driving mode from the start prohibited mode M9 to the start permitted mode M8.

In a case where the driving mode is the start standby mode M6 and the brake pedal operation is detected the mode setter 53 changes the driving mode from the start standby mode M6 to the stop maintenance mode M7. At this time, the start standby mode M6 may be either the start permitted mode M8 or the start prohibited mode M9.

In a case where the driving mode is the stop maintenance mode M7 and the release of the brake pedal operation and the operation on the second operation switch 36 are detected, the mode setter 53 changes the driving mode from the stop maintenance mode M7 to the start standby mode M6. At this time, the start standby mode M6 may be either the start permitted mode M8 or the start prohibited mode M9. In another embodiment, in a case where the driving mode is the stop maintenance mode M7 and the release of the brake pedal operation is detected, the mode setter 53 may change the driving mode from the stop maintenance mode M7 to the start standby mode M6.

In a case where the driving mode is the start permitted mode M8 and the surrounding environment turns into the start permitted state, the mode setter 53 changes the driving mode from the start permitted mode M8 to the travel assistance mode M4. This causes the travel controller 52 to start the vehicle 2 based on the surrounding environment.

In a case where the driving mode is the start standby mode M6 or the stop maintenance mode M7 and the accelerator pedal operation is detected, the mode setter 53 changes the driving mode from the start standby mode M6 or the stop maintenance mode M7 to the APOR mode M5. This allows the occupant to start the vehicle 2 by pressing the accelerator pedal 22. Thereafter, when the occupant releases the accelerator pedal operation, the driving mode changes from the APOR mode M5 to the travel assistance mode M4.

When the first operation switch 35 is turned off by the occupant in a case where the driving mode is the start standby mode M6 or the stop maintenance mode M7, the mode setter 53 changes the driving mode from the start standby mode M6 or the stop maintenance mode M7 to the manual driving mode M1.

In a case where the driving mode is the manual driving mode M1 and the first operation switch 35 is operated by the occupant when the vehicle 2 is stopped, the mode setter 53 changes the driving mode from the manual driving mode M1 to the stopped time driving assistance mode M3. At this time, in a case where the brake pedal 23 is pressed, the mode setter 53 may change the driving mode from the manual driving mode M1 to the stop maintenance mode M7. Further, in a case where the brake pedal 23 is not pressed and the state of the occupant is the surrounding monitoring state, the mode setter 53 may change the driving mode from the manual driving mode M1 to the start permitted mode M8. Further, in a case where the brake pedal 23 is not pressed and the state of the occupant is not the surrounding monitoring state, the mode setter 53 may change the driving mode from the manual driving mode M1 to the start prohibited mode M9.

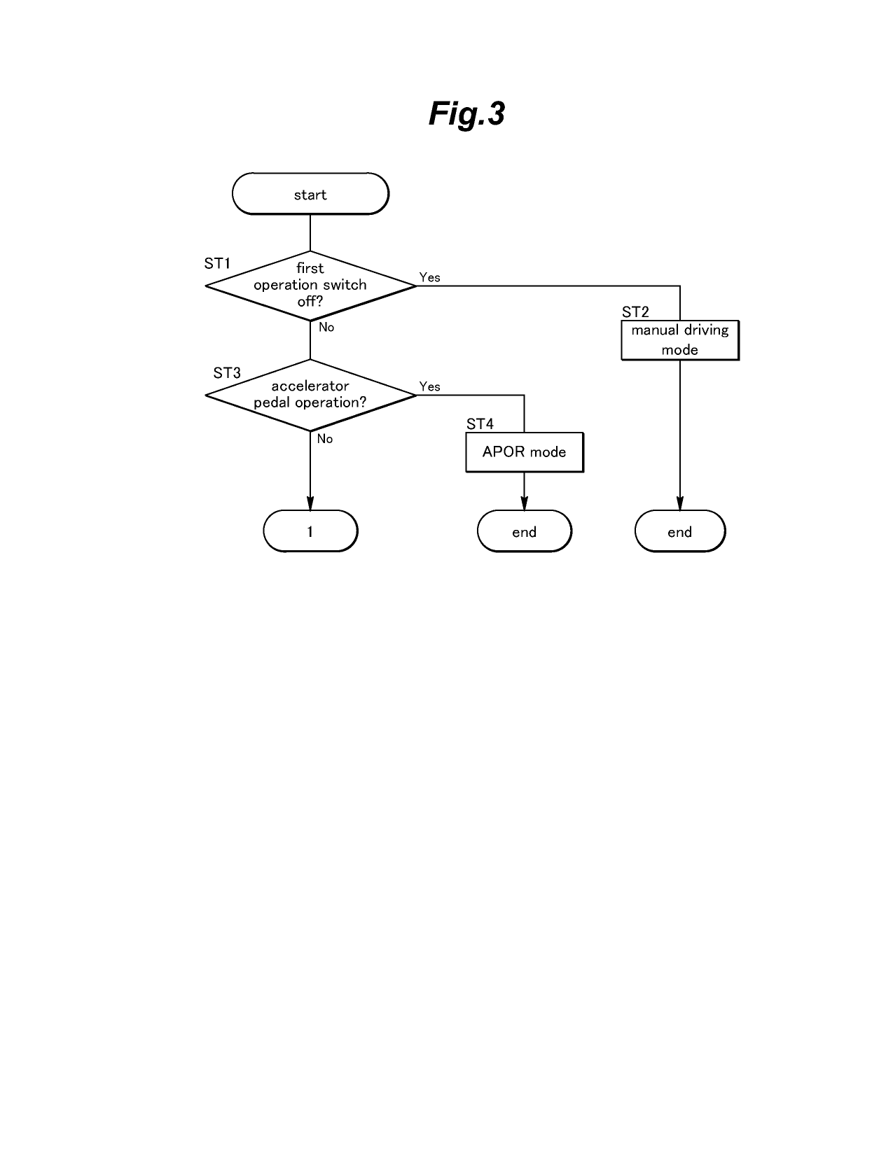

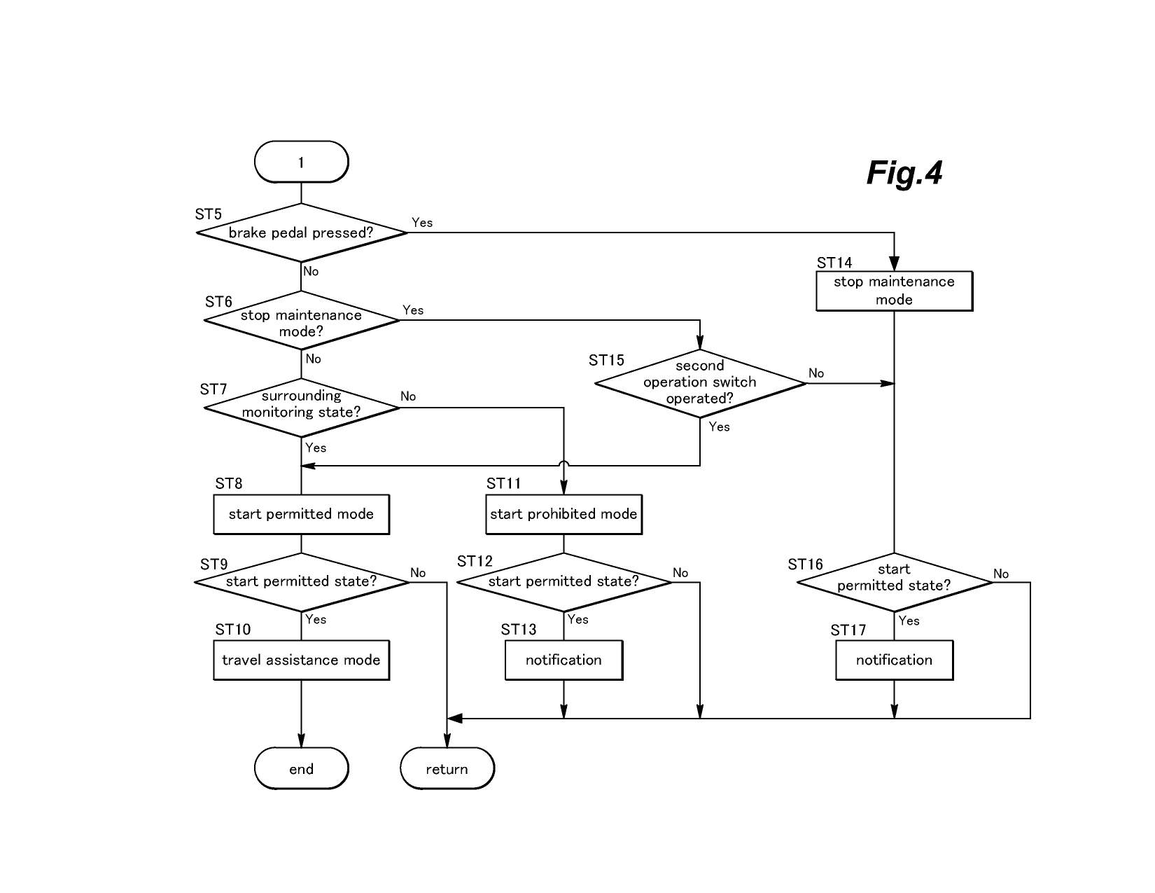

With reference to the flowcharts in FIGS. 3 and 4, an example of a procedure for stopped time driving assistance control (or stopped time driving control) executed by the driving control device 1 when the vehicle 2 is stopped will be described. The flowcharts in FIGS. 3 and 4 are connected to each other at "1" in the drawings. The driving control device 1 repeatedly executes the stopped time driving assistance control at prescribed time intervals when the vehicle 2 is stopped. When the stopped time driving assistance control is started, the driving mode is set to the start permitted mode M8. In another embodiment, when the stopped time driving assistance control is started, the driving mode may be set to the start prohibited mode M9 or the stop maintenance mode M7.

First, the driving control device 1 determines whether the first operation switch 35 is off (ST1). In a case where the first operation switch 35 is off (ST1: Yes), the driving control device 1 changes the driving mode to the manual driving mode M1 (ST2), and ends the stopped time driving assistance control.

In a case where the first operation switch 35 is on (ST1: No), the driving control device 1 determines whether the accelerator pedal operation is detected (present) based on the signal from the accelerator pedal 22 (ST3). In a case where the accelerator pedal operation is detected (ST3: Yes), the driving control device 1 changes the driving mode to the APOR mode M5 (ST4), and ends the stopped time driving assistance control. In the APOR mode M5, the driving control device 1 controls the propulsion device 3 according to the pressing amount of the accelerator pedal 22, and starts the vehicle 2.

In a case where the accelerator pedal operation is not detected (ST3: No), the driving control device 1 determines whether the brake pedal 23 is pressed (the brake pedal operation is detected) based on the signal from the brake pedal 23 (ST5). In a case where the brake pedal 23 is not pressed (ST5: No), the driving control device 1 determines whether the driving mode is the stop maintenance mode M7 (ST6).

In a case where the driving mode is not the stop maintenance mode M7 (ST6: No), the driving control device 1 determines whether the state of the occupant is the surrounding monitoring state (ST7). In a case where the state of the occupant is the surrounding monitoring state (ST7: Yes), the driving control device 1 sets the driving mode to the start permitted mode M8 (ST8).

After step ST8, the driving control device 1 determines whether the surrounding environment is in the start permitted state (ST9). In a case where the surrounding environment is in the start permitted state (ST9: Yes), the driving control device 1 changes the driving mode to the travel assistance mode M4 (ST10), and ends the stopped time driving assistance control. In the travel assistance mode M4, the driving control device 1 controls the propulsion device 3 according to the target vehicle speed and the inter-vehicle distance between the vehicle 2 and the preceding vehicle and starts the vehicle 2.

In a case of determining in step ST9 that the surrounding environment is not in the start permitted state (ST9: No), the driving control device 1 repeats the stopped time driving assistance control from step ST1. In this case, the driving mode is set to the start permitted mode M8, and the driving control device 1 controls the brake device 4 to maintain the vehicle 2 in the stopped state.

In step ST7, in a case where the state of the occupant is not the surrounding monitoring state (ST7: No), the driving control device 1 sets the driving mode to the start prohibited mode M9 (ST11).

After the process of step ST11, the driving control device 1 determines whether the surrounding environment is in the start permitted state (ST12). In a case where the surrounding environment is in the start permitted state (ST12: Yes), the driving control device 1 controls the display device 31 or the speaker 32 as the notification device and thereby makes the notification (ST13). The notification in step ST13 may be the notification that prompts the occupant to become the surrounding monitoring state. In this way, in a case where the driving mode is the start prohibited mode M9, the vehicle 2 does not start even if the surrounding environment is in the start permitted state.

In a case of determining in step ST12 that the surrounding environment is not in the start permitted state (ST12: No), the driving control device 1 repeats the stopped time driving assistance control from step ST1. In this case, the driving mode is set to the start prohibited mode M9, and the driving control device 1 controls the brake device 4 to maintain the vehicle 2 in the stopped state.

In a case where the brake pedal 23 is pressed (ST5: Yes), the driving control device 1 sets the driving mode to the stop maintenance mode M7 (ST14).

In a case of determining in step ST6 that the driving mode is the stop maintenance mode M7 (ST6: Yes), the driving control device 1 determines whether the second operation switch 36 is operated based on the signal from the second operation switch 36 (ST15). In a case where the second operation switch 36 is operated (ST15: Yes), the driving control device 1 changes the driving mode to the start permitted mode M8 (ST8). That is, in a case where pressing of the brake pedal 23 is not detected (ST5: No), the driving mode is the stop maintenance mode M7 (ST6: Yes), and the second operation switch 36 is operated (ST15:Yes), the driving mode is changed from the stop maintenance mode M7 to the start permitted mode M8.

In a case where the operation on the second operation switch 36 is not detected in step ST15 (ST15: No), or in a case where the process of step ST14 is executed, the driving control device 1 determines whether the surrounding environment is in the start permitted state (ST16). In a case where the surrounding environment is in the start permitted state (ST16: Yes), the driving control device 1 controls the display device 31 or the speaker 32, which serves as the notification device, and thereby makes the notification (ST17). The notification in step ST17 may be the notification that prompts the occupant to stop pressing the brake pedal 23 and to operate the second operation switch 36. In this manner, in a case where the driving mode is the stop maintenance mode M7, the vehicle 2 does not start even if the surrounding environment is in the start permitted state.

In a case of determining in step ST16 that the surrounding environment is not in the start permitted state (ST16: No), the driving control device 1 repeats the stopped time driving assistance control from step ST1. In this case, the driving mode is set to the stop maintenance mode M7, and the driving control device 1 controls the brake device 4 to maintain the vehicle 2 in the stopped state.

According to the driving control device 1 according to the embodiment, the occupant can change the driving mode to the stop maintenance mode M7 by performing the brake pedal operation when the vehicle 2 is stopped. In the stop maintenance mode M7, the vehicle 2 does not start even if the surrounding environment becomes the start permitted state. In this way, the driving control device 1 enables the vehicle 2 to start according to the intention of the occupant.

The embodiment is not limited to the above configuration and can be widely modified.

For example, in the stopped time driving assistance control of FIGS. 3 and 4, in a case where the operation on the second operation switch 36 is detected in step ST15 (ST15: Yes), the process may proceed to step ST7 to determine whether the state of the occupant is the surrounding monitoring state.

The determination in step ST15 may be replaced with the determination as to whether the accelerator pedal operation is detected (present). In this embodiment, in a case where the accelerator pedal operation is detected (ST15: Yes), the process may proceed to step ST8.

In another embodiment, the start prohibited mode M9 may be omitted. In this embodiment, the start standby mode M6 becomes the same as the start permitted mode M8. When the surrounding environment turns into the start permitted state in the start standby mode M6, the mode setter 53 may change the driving mode from the start standby mode M6 to the travel assistance mode M4. In this embodiment, steps ST7, ST11, ST12, and ST13 in FIGS. 3 and 4 may be omitted. In a case where the determination result in step ST6 is No, the process may proceed to step ST8.

In another embodiment, steps ST6 and ST15 may be omitted. In this embodiment, in a case where the determination result in step ST5 is No, the process may proceed to step ST7.

In a case where the driving mode is the start permitted mode M8 and the surrounding environment is in the start permitted state, the travel controller 52 may control the brake device 4 and the propulsion device 3 to start the vehicle 2. Then, when the vehicle 2 starts, that is, when the vehicle speed becomes greater than zero, the mode setter 53 may change the driving mode from the start permitted mode M8 to the travel assistance mode M4.

The above embodiments may be described as follows:

According to one aspect, a driving control device 1 of a vehicle 2 comprises: a surrounding environment recognizer 51 configured to recognize a surrounding environment of the vehicle 2; a travel controller 52 configured to control acceleration and deceleration of the vehicle 2 according to a driving mode; a mode setter 53 configured to change the driving mode; and an operation detector 56 configured to detect a brake pedal operation by an occupant,wherein the driving mode includes: a start standby mode M6 in which the travel controller 52 starts the vehicle 2 according to the surrounding environment when the vehicle 2 is stopped; and a stop maintenance mode M7 in which the travel controller 52 maintains the stopped state of the vehicle 2 when the vehicle 2 is stopped, and in a case where the driving mode is the start standby mode M6 and the brake pedal operation is detected, the mode setter 53 changes the driving mode from the start standby mode M6 to the stop maintenance mode M7.

According to this aspect, it is possible to provide the driving control device 1 that enables the vehicle 2 to start according to the intention of the occupant. The occupant can change the driving mode to the stop maintenance mode M7 by operating the brake pedal 23. In the stop maintenance mode M7, the vehicle 2 is maintained in the stopped state, so that the vehicle 2 is prevented from starting at a timing against the intention of the occupant.

Preferably, the operation detector 56 is configured to detect an operation on an operation switch by the occupant, and in a case where the driving mode is the stop maintenance mode M7 and both release of the brake pedal operation and the operation on the operation switch are detected, the mode setter 53 changes the driving mode from the stop maintenance mode M7 to the start standby mode M6.

According to this aspect, the driving mode changes from the stop maintenance mode M7 to the start standby mode M6 according to the operation by the occupant, and the start of the vehicle 2 is permitted. This enables the vehicle 2 to start according to the intention of the occupant.

Preferably, the driving control device 1 further comprises an occupant state determiner 54 configured to determine a state of the occupant, wherein the start standby mode M6 includes: a start permitted mode M8 in which start of the vehicle 2 is permitted; and a start prohibited mode M9 in which the start of the vehicle 2 is prohibited, and in the start standby mode M6, the mode setter 53 changes between the start permitted mode M8 and the start prohibited mode M9 according to the state of the occupant.

According to this aspect, since the driving mode changes between the start permitted mode M8 and the start prohibited mode M9 according to the state of the occupant, it becomes possible to start the vehicle 2 according to the intention of the occupant.

Preferably, the driving mode includes a travel assistance mode M4 in which the travel controller 52 controls the acceleration and deceleration of the vehicle 2 according to the surrounding environment, and when the surrounding environment turns into a start permitted state in the start standby mode M6, the mode setter 53 changes the driving mode from the start standby mode M6 to the travel assistance mode M4.

According to this aspect, when the surrounding environment turns into the start permitted state, the driving mode changes from the start standby mode M6 to the travel assistance mode M4, and the vehicle 2 starts.

Preferably, the operation detector 56 is configured to detect an accelerator pedal operation by the occupant, in a case where the driving mode is the stop maintenance mode M7 and the accelerator pedal operation is detected, the mode setter 53 changes the driving mode from the stop maintenance mode M7 to an accelerator pedal override mode M5 (APOR mode M5), and in the accelerator pedal override mode M5, the travel controller 52 accelerates the vehicle 2 based on the accelerator pedal operation.

According to this aspect, even if the driving mode is the stop maintenance mode M7, the occupant can start the vehicle 2 by pressing the accelerator pedal 22.

Preferably, in a case where the driving mode is the accelerator pedal override mode M5 and the accelerator pedal operation is released, the mode setter 53 changes the driving mode from the accelerator pedal override mode M5 to the travel assistance mode M4.

According to this aspect, after the vehicle 2 starts as the occupant presses the accelerator pedal 22, the occupant can change the driving mode to the travel assistance mode M4 by releasing pressing of the accelerator pedal 22.

Preferably, the driving control device 1 further comprises a notifier 57 configured to control the notification device, wherein when the driving mode is the stop maintenance mode M7, the notifier 57 controls the notification device and thereby makes the notification.

According to this aspect, the occupant can recognize that the driving mode is the stop maintenance mode M7.

Preferably the driving control device 1 further comprises a notifier 57 configured to control the notification device, wherein in a case where the driving mode is the stop maintenance mode M7 and the surrounding environment is in a start permitted state, the notifier 57 controls the notification device and thereby makes the notification.

According to this aspect, the occupant can recognize that the driving mode is the stop maintenance mode M7 and that the vehicle 2 will not automatically start.

Preferably, in the travel assistance mode M4, the travel controller 52 executes adaptive cruise control or autonomous driving control.

According to this aspect, the travel controller 52 can execute various driving assistance functions.

According to another aspect, a driving control method comprises: detecting, by a computer, a surrounding environment of a vehicle 2; controlling, by the computer, acceleration and deceleration of the vehicle 2 according to a driving mode including a start standby mode M6 in which the vehicle 2 is started according to the surrounding environment when the vehicle 2 is stopped and a stop maintenance mode M7 in which the stopped state of the vehicle 2 is maintained when the vehicle 2 is stopped; and changing, by the computer, the driving mode from the start standby mode M6 to the stop maintenance mode M7 in a case where the driving mode is the start standby mode M6 and a brake pedal operation is detected.

According to this aspect, it is possible to provide the driving control method that enables the vehicle 2 to start according to the intention of the occupant.

According to another aspect, a non-transitory computer-readable storage medium comprising a control program, wherein the control program, when executed by a computer, executes a driving control method comprises: detecting, by the computer, a surrounding environment of a vehicle 2; controlling, by the computer, acceleration and deceleration of the vehicle 2 according to a driving mode including a start standby mode M6 in which the vehicle 2 is started according to the surrounding environment when the vehicle 2 is stopped and a stop maintenance mode M7 in which the stopped state of the vehicle 2 is maintained when the vehicle 2 is stopped; and changing, by the computer, the driving mode from the start standby mode M6 to the stop maintenance mode M7 in a case where the driving mode is the start standby mode M6 and a brake pedal operation is detected.

According to this aspect, it is possible to provide the storage medium that enables the vehicle 2 to start according to the intention of the occupant.

1. A driving control device of a vehicle, comprising:
a surrounding environment recognizer configured to recognize a surrounding environment of the vehicle;
a travel controller configured to control acceleration and deceleration of the vehicle according to a driving mode;
a mode setter configured to change the driving mode; and
an operation detector configured to detect a brake pedal operation by an occupant,
wherein the driving mode includes:
a start standby mode in which the travel controller starts the vehicle according to the surrounding environment when the vehicle is stopped; and
a stop maintenance mode in which the travel controller maintains a stopped state of the vehicle when the vehicle is stopped, and
in a case where the driving mode is the start standby mode and the brake pedal operation is detected, the mode setter changes the driving mode from the start standby mode to the stop maintenance mode.

2. The driving control device according to claim 1, wherein the operation detector is configured to detect an operation on an operation switch by the occupant, and
in a case where the driving mode is the stop maintenance mode and both release of the brake pedal operation and the operation on the operation switch are detected, the mode setter changes the driving mode from the stop maintenance mode to the start standby mode.

3. The driving control device according to claim 1, further comprising an occupant state determiner configured to determine a state of the occupant,
wherein the start standby mode includes:
a start permitted mode in which start of the vehicle is permitted; and
a start prohibited mode in which the start of the vehicle is prohibited, and
in the start standby mode, the mode setter changes between the start permitted mode and the start prohibited mode according to the state of the occupant.

4. The driving control device according to claim 1, wherein the driving mode includes a travel assistance mode in which the travel controller controls the acceleration and deceleration of the vehicle according to the surrounding environment, and
when the surrounding environment turns into a start permitted state in the start standby mode, the mode setter changes the driving mode from the start standby mode to the travel assistance mode.

5. The driving control device according to claim 4, wherein the operation detector is configured to detect an accelerator pedal operation by the occupant,
in a case where the driving mode is the stop maintenance mode and the accelerator pedal operation is detected, the mode setter changes the driving mode from the stop maintenance mode to an accelerator pedal override mode, and
in the accelerator pedal override mode, the travel controller accelerates the vehicle based on the accelerator pedal operation.

6. The driving control device according to claim 5, wherein in a case where the driving mode is the accelerator pedal override mode and the accelerator pedal operation is released, the mode setter changes the driving mode from the accelerator pedal override mode to the travel assistance mode.

7. The driving control device according to claim 1, further comprising a notifier configured to control a notification device,
wherein when the driving mode is the stop maintenance mode, the notifier controls the notification device and thereby makes a notification.

8. The driving control device according to claim 1, further comprising a notifier configured to control a notification device,
wherein in a case where the driving mode is the stop maintenance mode and the surrounding environment is in a start permitted state, the notifier controls the notification device and thereby makes a notification.

9. The driving control device according to claim 4, wherein in the travel assistance mode, the travel controller executes adaptive cruise control or autonomous driving control.

10. A driving control method, comprising:
detecting, by a computer, a surrounding environment of a vehicle;
controlling, by the computer, acceleration and deceleration of the vehicle according to a driving mode including a start standby mode in which the vehicle is started according to the surrounding environment when the vehicle is stopped and a stop maintenance mode in which a stopped state of the vehicle is maintained when the vehicle is stopped; and
changing, by the computer, the driving mode from the start standby mode to the stop maintenance mode in a case where the driving mode is the start standby mode and a brake pedal operation is detected.

11. A non-transitory computer-readable storage medium comprising a control program, wherein the control program, when executed by a computer, executes a driving control method, comprising:
detecting, by the computer, a surrounding environment of a vehicle;
controlling, by the computer, acceleration and deceleration of the vehicle according to a driving mode including a start standby mode in which the vehicle is started according to the surrounding environment when the vehicle is stopped and a stop maintenance mode in which a stopped state of the vehicle is maintained when the vehicle is stopped; and
changing, by the computer, the driving mode from the start standby mode to the stop maintenance mode in a case where the driving mode is the start standby mode and a brake pedal operation is detected.
